(19) United States
(12) Patent Application Publication
(10) Pub. No.: US 2009/0313637 A1
(43) Pub. Date: Dec. 17, 2009

(54) METHOD AND SYSTEM FOR PREFERENTIAL REPLY ROUTING

(75) Inventors: Tom Evans, Southampton (GB); Graham D. Wallis, West Wellow (GB); David Ware, Redlynch (GB); Christopher Wilkinson, Southampton (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/138,585

(22) Filed: Jun. 13, 2008

(51) Int. Cl. G06F 9/54

(52) U.S. Cl. 719/314

(57) ABSTRACT

A method for preferential reply routing, the method includes: receiving a request-reply message from a requesting application; detecting there is a preferred partition of a reply queue managed locally to an application server to which the requesting application is connected; qualifying a name of a reply queue stored in the request-reply message so that the name refers to the local partition that is managed locally to the application server; determining whether the local partition is available; wherein in the event the local partition is available: storing a reply message in the local partition; and retrieving the reply message from the local partition in response to the requesting application.

### BACKGROUND OF THE INVENTION

1. Field of the Invention

This invention relates generally to communications between computers, and more particularly to a method and system for retrieval of reply messages from partition reply queues.

2. Description of the Related Art

Electronic mail (email) and electronic commerce have become a central feature of modern life, and users have come to expect to receive electronic mail messages and conduct transactions at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

The widespread proliferation and availability of electronic messaging and electronic commerce has provided an efficient method to communicate information and conduct transactions. In fact, electronic messaging (with its near instantaneous delivery from sender to receiver) is the preferred method of personal and business communication where hardcopy signatures are not required. Electronic commerce has become a preferred method for banking, investing, and for the purchase of goods and services. In addition, the ease of use and minimal cost of distribution has led to mass email to large distribution lists, as well as using email as a broad collaborative tool.

In order to conduct electronic messaging and electronic commerce, computer applications communicate by sending messages to one another. An application may send a message that conveys a (unidirectional) notification of some data. In other cases, an application may send a request message to which the application expects to receive a response, in the form of a reply message. As an example of request-reply messaging, consider an account balance inquiry made by a user in a banking application. The application request conveys the account number and the operation to perform (balance inquiry). The reply conveys the result of the inquiry—(e.g., date, time, account number, and returned balance). The application that sends the request is referred to as the “requester”. The application that receives the request and sends the reply is referred to as the “responder”.

An application's message is generally received in a queue. A queue is a destination to which a message is addressed. A queue acts as a mailbox that is managed by a computer server. A queue is configured to store messages until the messages are received by the application that draws the messages from the queue.

An address is assigned by an application that sends a message, and specifies the name of the queue to which the message should be sent. A message is said to be “addressed” to a queue. In one-way messaging a sending application simply names the target queue to which a message should be sent. The queue name may be specified in a message or alongside the message, as meta-data or a parameter. In request-reply messaging, the requester inserts the name of the reply queue into a pre-arranged field in the request message. When the responder receives the request message and processes it, the responder utilizes the name of the reply queue to determine where to send the reply message.

An extension of the queue concept is a clustered queue. A clustered queue is a queue that is managed by a number of servers, to provide additional scalability or bandwidth, to facilitate more messages to be processed and stored. A clustered queue is logically just a single queue, except that where a queue may be thought of as a mailbox, a clustered queue would have an array of mailboxes that are referred to as “partitions” of the queue. Each message addressed to the clustered queue is routed to one of the partitions. A partition is generally chosen dynamically by the messaging system so that the programming model experienced by an application is as simple as possible, by making the queue appear as one addressable entity, and having the messaging system make the workload balancing and routing decisions automatically. A typical use for a clustered queue is to support multiple parallel responders, each of which serves one partition of the request queue. The parallelism, of the responders, allows multiple requests to be handled simultaneously. The parallelism works naturally for request processing because there is no reason for a particular request to prefer (or be tied to) a particular partition of the clustered request queue—i.e., it does not matter which of the responders handles the request, provided one of them does.

### SUMMARY OF THE INVENTION

Embodiments of the present invention include a method, article, and system for preferential reply routing, wherein the method includes: receiving a request-reply message from a requesting application; detecting there is a preferred partition of a reply queue managed locally to an application server to which the requesting application is connected; qualifying a name of a reply queue stored in the request-reply message so that the name refers to the local partition that is managed locally to the application server; determining whether the local partition is available; wherein in the event the local partition is available: storing a reply message in the local partition; and retrieving the reply message from the local partition in response to the requesting application.

An article comprising one or more computer-readable storage media containing instructions that when executed by a computer enables preferential reply routing; wherein the method further includes: receiving a request-reply message from a requesting application; detecting there is a preferred partition of a reply queue managed locally to an application server to which the requesting application is connected; qualifying a name of a reply queue stored in the request-reply message so that the name refers to the local partition that is managed locally to the application server; determining whether the local partition is available; wherein in the event the local partition is available: storing a reply message in the local partition; and retrieving the reply message from the local partition in response to the requesting application.

A system for preferential reply routing, the system includes: one or more server devices in communication with one or more client devices through a network; wherein the one or more client devices are configured to allow an originating user to do the following: compose a request-reply message with a requesting application on the one or more client devices; send the request-reply message to the one or more servers; and wherein the one or more server devices form a messaging system configured to do the following: receive a request-reply message from a requesting application; detect whether there is a preferred partition of a reply queue managed locally to an application server to which the requesting application is connected; qualify a name of a reply queue stored in the request-reply message so that the name refers to the local partition that is managed locally to the application server; determine whether the local partition is available; wherein in the event the local partition is available: a reply message is stored in the local partition; and the reply message is retrieved from the local partition in response to the requesting application.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, a solution is technically achieved for a method, article, and system for improved efficiency of retrieval of reply messages from partition reply queues.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow chart for preferential reply routing according to an embodiment of the invention.

FIG. 2 illustrates a system for implementing embodiments of the invention.

The detailed description explains the preferred embodiments of the invention, together with advantages and features, by way of example with reference to the drawings.

### DETAILED DESCRIPTION

The explosive growth in the use of electronic mail (email) and electronic commerce has lead to increasing demands on networks and servers. However, the mechanisms that are presently available to send, receive and process email and electronic commerce transaction messaging requests are not fully optimized from the server perspective.

In order to improve the efficiency of the retrieval of the reply messages, it is preferable for applications or messaging systems to route reply messages to known partitions. However, routing to known partitions is at best preferential, because the choice of partition cannot be guaranteed, as the messaging system may lose connectivity to a partition, or a partition may become full and no longer able to accept messages, which consequently must be routed to an alternate partition.

Embodiments of the invention provide a method and system for improved efficiency of the retrieval of reply messages from partition reply queues. Embodiments of the invention introduce the concept of a “preferred partition”. A preferred partition allows the requester to nominate one partition as the one that should be chosen for a message, if possible, with the message being routed to an alternate partition only if the preferred partition is not reachable, or available for some reason, such as the preferred partition is full. Various implementations of embodiments of the invention are possible, with the preferred partition either being explicitly chosen by the requester, or implicitly selected by the system, during the processing of the request message.

In an embodiment of the invention, during the sending of a request message, the messaging system detects that there is a partition of the reply queue managed locally to the application server to which the requesting application is connected, and the messaging system qualifies (assigns) the name of the reply queue stored in the request message so that it refers to that local partition. The requesting application attempts to retrieve the reply message from the local partition and will in general be satisfied. Only in the event of the reply message being routed to an alternate partition (if the qualified partition is unavailable) is there a need for any additional processing (either implicit or explicit) in order to facilitate retrieval of the reply message by the requesting application.

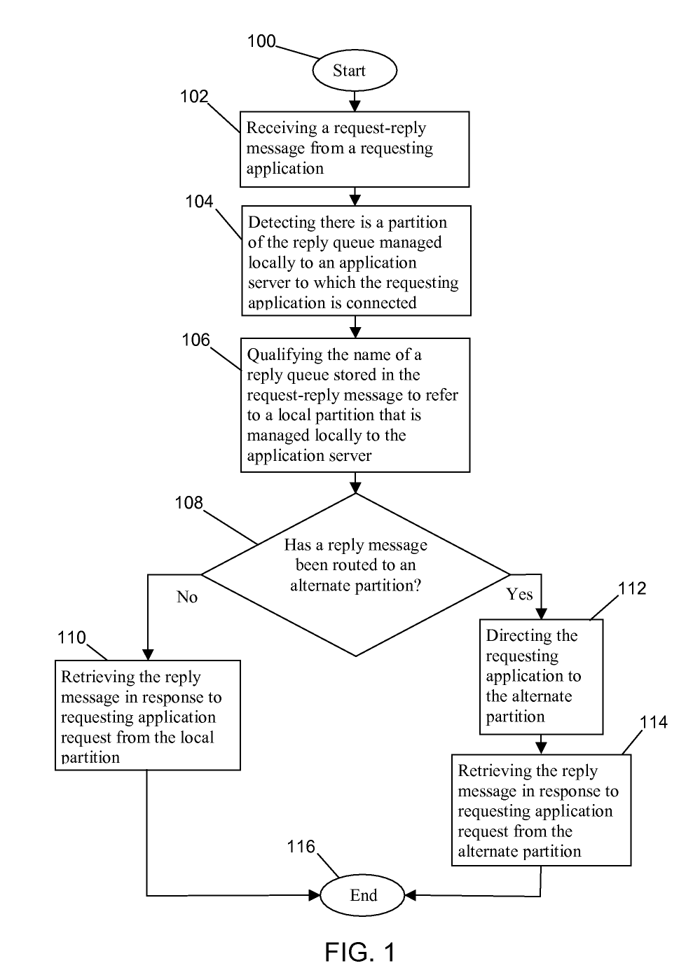

FIG. 1 illustrates a flow chart for preferential reply routing according to an embodiment of the invention. The process starts (block 100) with a messaging system receiving a request-reply message from a requesting application (block 102), and detecting there is a partition of the reply queue managed locally to an application server to which the requesting application is connected (block 104). The messaging system qualifies the name of a reply queue stored in the request-reply message so that the name refers to a local partition that is managed locally to the application server (block 106). In the event the qualified partition is available (decision block 108 is No), the reply message is retrieved by the messaging system from the qualified local partition in response to the requesting application (block 110), and the process ends (block 116). In the event the qualified partition is unavailable, the messaging system routes the reply message to an alternate partition (decision block 108 is Yes), and the requesting application is directed by the messaging system to the alternate partition (block 112) for the retrieval of the reply message (block 114), and the process ends (block 116).

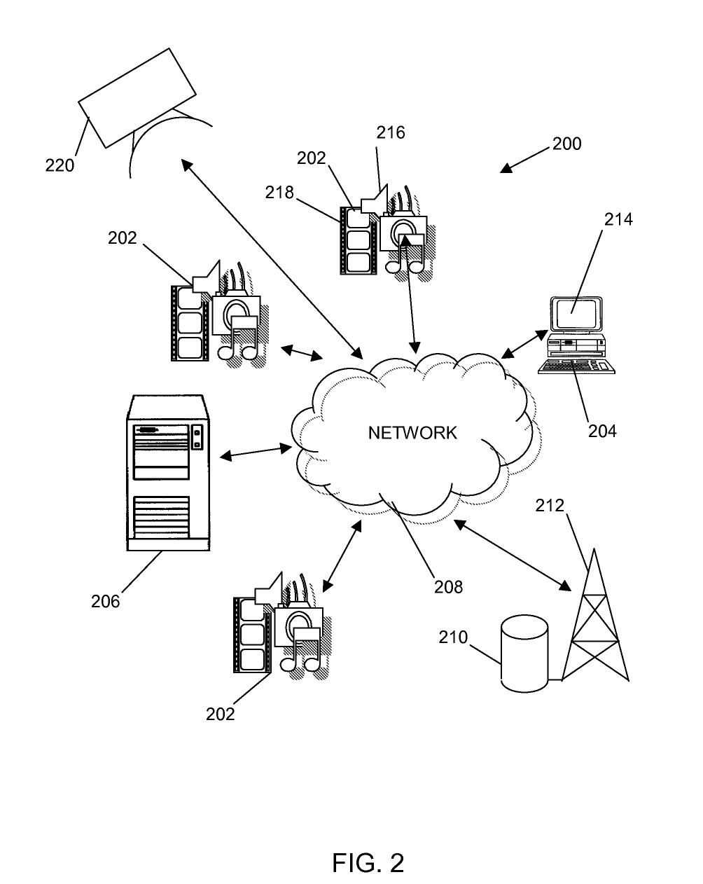

FIG. 2 is a block diagram of an exemplary system 200 configured for improved efficiency of retrieval of reply messages from partitioned reply queues. The system 200 includes multimedia devices 202, and desktop computer devices 204 configured with display capabilities 214. The multimedia devices 202 may be mobile communication and entertainment devices, such as cellular phones and mobile computing devices that are wirelessly connected to a network 208. The multimedia devices 202 have video displays 218 and audio outputs 216. The multimedia devices 202 and desktop computer devices 204 may be configured with software with a GUI for initiating request-reply messages. The network 208 may be any type of known network including a fixed wire line network, cable and fiber optics, over the air broadcasts, satellite 220, local area network (LAN), wide area network (WAN), global network (e.g., Internet), intranet, etc. with data/Internet capabilities as represented by server 206. Communication aspects of the network are represented by cellular base station 212 and antenna 210. In a preferred embodiment, the network 208 is a LAN and each remote device 202 and desktop device 204 executes a user interface application (e.g., web browser) to contact the server system 206 through the network 208. Alternatively, the remote devices 202 and 204 may be implemented using a device programmed primarily for accessing network 208 such as a remote client.

The preferential reply software, of embodiments of the invention, may be resident on the individual multimedia devices 202 and desktop computers 204, or stored within the server 206 or cellular base station 210.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for preferential reply routing, wherein the method comprises:
receiving a request-reply message from a requesting application;
detecting there is a preferred partition of a reply queue managed locally to an application server to which the requesting application is connected;
qualifying a name of a reply queue stored in the request-reply message so that the name refers to the local partition that is managed locally to the application server;
determining whether the local partition is available;
wherein in the event the local partition is available:
storing a reply message in the local partition; and
retrieving the reply message from the local partition in response to the requesting application.

2. The method of claim 1, wherein in the event the local partition is unavailable:
routing the reply message to an alternate partition;
directing the requesting application to the alternate partition; and
retrieving the reply message from the alternate partition in response to the requesting application.

3. The method of claim 1, wherein the preferred partition is explicitly chosen by the requesting application.

4. The method of claim 1, wherein the preferred partition is implicitly selected by a messaging system that receives the request-reply message from the requesting application.

5. An article comprising one or more computer-readable storage media containing instructions that when executed by a computer enables preferential reply routing; wherein the method further comprises:
receiving a request-reply message from a requesting application;
detecting there is a preferred partition of a reply queue managed locally to an application server to which the requesting application is connected;
qualifying a name of a reply queue stored in the request-reply message so that the name refers to the local partition that is managed locally to the application server;
determining whether the local partition is available;
wherein in the event the local partition is available:
storing a reply message in the local partition; and
retrieving the reply message from the local partition in response to the requesting application.

6. The article of claim 5, wherein in the event the local partition is unavailable:
routing the reply message to an alternate partition;
directing the requesting application to the alternate partition; and
retrieving the reply message from the alternate partition in response to the requesting application.

7. The article of claim 5, wherein the preferred partition is explicitly chosen by the requesting application.

8. The article of claim 5, wherein the preferred partition is implicitly selected by a messaging system that receives the request-reply message from the requesting application.

9. A system for preferential reply routing, the system comprising:
one or more server devices in communication with one or more client devices through a network;
wherein the one or more client devices are configured to allow an originating user to do the following:
compose a request-reply message with a requesting application on the one or more client devices;
send the request-reply message to the one or more servers; and
wherein the one or more server devices form a messaging system configured to do the following:
receive a request-reply message from a requesting application;
detect whether there is a preferred partition of a reply queue managed locally to an application server to which the requesting application is connected;
qualify a name of a reply queue stored in the request-reply message so that the name refers to the local partition that is managed locally to the application server;
determine whether the local partition is available;
wherein in the event the local partition is available:
a reply message is stored in the local partition; and
the reply message is retrieved from the local partition in response to the requesting application.

10. The system of claim 9, wherein in the event the local partition is unavailable the messaging system:
routes the reply message to an alternate partition;
directs the requesting application to the alternate partition; and
retrieves the reply message from the alternate partition in response to the requesting application.

11. The system of claim 9, wherein the preferred partition is explicitly chosen by the requesting application.

12. The system of claim 9, wherein the preferred partition is implicitly selected by the messaging system that receives the request-reply message from the requesting application.
